(19) United States
(12) Patent Application Publication
(10) Pub. No.: US 2026/0118720 A1
(43) Pub. Date: Apr. 30, 2026

(54) LIQUID CRYSTAL ELEMENT

(71) Applicant: Japan Display Inc., Tokyo (JP)

(72) Inventors: Shunichi KIMURA, Tokyo (JP); Toshiharu MATSUSHIMA, Tokyo (JP)

(21) Appl. No.: 19/288,656

(22) Filed: Aug. 1, 2025

(30) Foreign Application Priority Data
Aug. 21, 2024 (JP) 2024-139687

(51) Int. Cl. G02F 1/1343; G02F 1/1335

(52) U.S. Cl. CPC G02F 1/134363; G02F 1/133512

(57) ABSTRACT

According to an aspect, a liquid crystal element includes: first electrode sets each including a first electrode and a second electrode on a first substrate and a third electrode and a fourth electrode on a second substrate; second electrode sets each including a fifth electrode and a sixth electrode on the second substrate; a liquid crystal layer between the first and second substrates; and light-shielding films. In each first electrode set, the first and second electrodes face each other in a second direction, the third electrode overlaps the first electrode, the fourth electrode overlaps the second electrode. The fifth and sixth electrodes face each other in the second direction. The first and second electrode sets are alternately arranged in the second direction. The light-shielding films each overlap a gap between the third and fourth electrodes in a corresponding one of the first electrode sets.

### CROSS-REFERENCE TO RELATED APPLICATION

This application claims the benefit of priority from Japanese Patent Application No. 2024-139687 filed on Aug. 21, 2024, the entire contents of which are incorporated herein by reference.

### BACKGROUND

### 1. Technical Field

What is disclosed herein relates to a liquid crystal element.

### 2. Description of the Related Art

Japanese Patent Application Laid-open Publication No. 2015-174551 (JP-A-2015-174551) discloses a headlight capable of controlling light distribution. The headlight of JP-A-2015-174551 reflects light from a light source by using a mirror, converges the reflected light with a lens, and projects light toward the front side of the vehicle. The direction of light projection is adjusted by adjusting the angle of the mirror.

Japanese Patent Application Laid-open Publication No. 2023-63255 (JP-A-2023-63255) discloses an illumination device including a lamp unit including a light source, and an arm coupled to the lamp unit. The arm includes a first arm and a second arm coupled to each other in a relatively rotatable manner. The lamp unit and the second arm are coupled to each other in a relatively rotatable manner. The emission direction of light from the light source is adjusted by adjusting the angle between the first and second arms and the angle between the lamp unit and the second arm.

In a device capable of adjusting the emission direction of light as in JP-A-2015-174551 or JP-A-2023-63255, the emission direction of light is adjusted through operation of a movable part in a mechanism including a plurality of mechanical components. The configuration of such a device is desired to be simplified.

For the foregoing reasons, there is a need for a liquid crystal element capable of easily adjusting the emission direction of light.

### SUMMARY

According to an aspect, a liquid crystal element includes: a first substrate and a second substrate facing each other; a plurality of first electrode sets each including a first electrode, a second electrode, a third electrode, and a fourth electrode, the first and second electrodes being disposed on the first substrate, the third and fourth electrodes being disposed on the second substrate; a plurality of second electrode sets each including a fifth electrode and a sixth electrode, the fifth and sixth electrodes being disposed on the second substrate; a liquid crystal layer positioned between the first and second substrates; and a plurality of light-shielding films. In each of the first electrode sets, the first and second electrodes extend in a first direction and face each other in a second direction orthogonal to the first direction, the third electrode extends in the first direction and overlaps the first electrode in plan view, the fourth electrode extends in the first direction and overlaps the second electrode in plan view. The fifth and sixth electrodes in each of the second electrode sets extend in the first direction and face each other in the second direction. The first and second electrode sets are alternately arranged in the second direction. The light-shielding films each overlap a gap between the third and fourth electrodes in a corresponding one of the first electrode sets in plan view.

According to an aspect, a liquid crystal element includes: a first substrate and a second substrate facing each other; a plurality of first electrode sets each including a first electrode, a second electrode, a third electrode, and a fourth electrode, the first and second electrodes being disposed on the first substrate, the third and fourth electrodes being disposed on the second substrate; a plurality of second electrode sets disposed on the second substrate and each including a fifth electrode and a sixth electrode; and a liquid crystal layer positioned between the first and second substrates. The first, second, third, and fourth electrodes extend in a first direction. A length of each of the first electrodes is longer than a length of each of the second electrodes, a length of each of the third electrodes, and a length of each of the fourth electrodes in a second direction orthogonal to the first direction. In one of the first electrode sets, the second electrode is disposed closer to the second substrate than the first electrode and overlaps, in plan view, a first end portion of the first electrode on a first end side in the second direction, the third electrode overlaps, in plan view, a second end portion of the first electrode on a second end side in the second direction, and the fourth electrode overlaps the second electrode in plan view. The fifth and sixth electrodes in each of the second electrode sets extend in the first direction and face each other in the second direction. The first and second electrode sets are alternately arranged in the second direction. The first electrodes have light-shielding properties.

### BRIEF DESCRIPTION OF THE DRAWINGS

FIG. 1 is a conceptual diagram of a liquid crystal element according to a first embodiment of the present disclosure;

FIG. 2 is a plan view of the liquid crystal element according to the first embodiment of the present disclosure;

FIG. 3 is a sectional view of the liquid crystal element along line III-III illustrated in FIG. 2;

FIG. 4 is a plan view illustrating an arrangement of first electrodes and second electrodes illustrated in FIG. 3;

FIG. 5 is a plan view illustrating an arrangement of third electrodes and fourth electrodes illustrated in FIG. 3;

FIG. 6 is a diagram illustrating the tilt degree of liquid crystal molecules when the liquid crystal element illustrated in FIG. 3 refracts emission light in a fourth direction;

FIG. 7 is a diagram illustrating the phase difference of emission light passing through a liquid crystal layer of the liquid crystal element illustrated in FIG. 6;

FIG. 8 is a cross-sectional view of a liquid crystal element of a first comparative example;

FIG. 9 is a diagram illustrating the tilt degree of liquid crystal molecules when the liquid crystal element of the first comparative example illustrated in FIG. 8 refracts emission light in the fourth direction;

FIG. 10 is a cross-sectional view of a liquid crystal element of a second comparative example;

FIG. 11 is a diagram illustrating the tilt degree of liquid crystal molecules when the liquid crystal element of the second comparative example illustrated in FIG. 10 refracts emission light in the fourth direction;

FIG. 12 is a cross-sectional view of a liquid crystal element according to a second embodiment of the present disclosure; and

FIG. 13 is a cross-sectional view of a liquid crystal element according to a third embodiment of the present disclosure.

### DETAILED DESCRIPTION

Embodiments of the present disclosure will be described below with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

In this disclosure, when an element is described as being “on” another element, the element can be directly on the other element, or there can be one or more elements between the element and the other element.

A first direction D1 and a second direction D2 illustrated in the drawings correspond to directions parallel to the plate surfaces of substrates included in a liquid crystal element 1 to be described later. The first direction D1 and the second direction D2 correspond to directions along sides of the liquid crystal element 1. In the first direction D1, a side indicated by an arrow is a positive D1 side, and a side opposite to the positive D1 side is a negative D1 side. In the second direction D2, a side indicated by an arrow is a positive D2 side, and a side opposite to the positive D2 side is a negative D2 side.

A third direction D3 corresponds to the thickness direction of the liquid crystal element 1. In the third direction D3, a side indicated by an arrow is a positive D3 side, and a side opposite to the positive D3 side is a negative D3 side. The positive D3 side in the third direction D3 corresponds to the front surface side of the liquid crystal element 1, and the negative D3 side in the third direction D3 corresponds to the back surface side of the liquid crystal element 1. In the present specification, “plan view” is the view of the liquid crystal element 1 in the third direction D3. The first direction D1, the second direction D2, and the third direction D3 are exemplary, and the present disclosure is not limited to these directions.

### First Embodiment

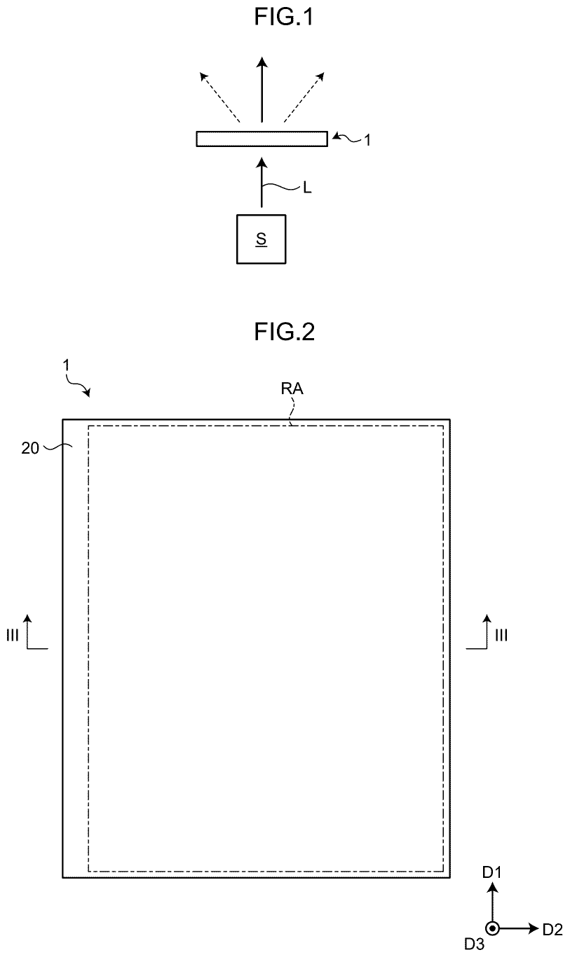

FIG. 1 is a conceptual diagram of the liquid crystal element 1 according to a first embodiment of the present disclosure. The liquid crystal element 1 is a refractive plate that refracts light. Emission light L emitted from a light source S enters the liquid crystal element 1. The light source S is, for example, an illumination device such as a vehicle headlight or a spotlight.

When no voltage is applied, the liquid crystal element 1 transmits the emission light L as illustrated with the solid arrow without changing the direction (emission direction) in which the emission light L travels. When voltage is applied, the liquid crystal element 1 refracts the emission light L in one of two directions illustrated with the dashed arrows (to be described later in detail).

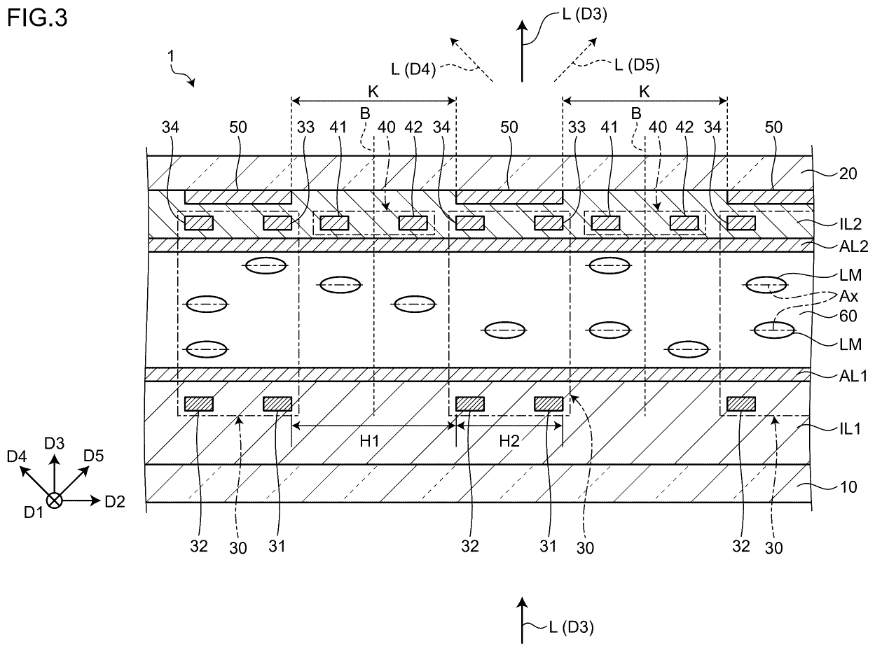

FIG. 2 is a plan view of the liquid crystal element 1 according to the first embodiment of the present disclosure. FIG. 3 is a sectional view of the liquid crystal element 1 along line III-III illustrated in FIG. 2. The sectional view of the liquid crystal element 1 illustrated in FIG. 3 illustrates a sectional shape of the liquid crystal element 1 when cut along a plane orthogonal to the first direction D1.

The liquid crystal element 1 includes a first substrate 10, a second substrate 20, a plurality of first electrode sets 30, a plurality of second electrode sets 40, a plurality of light-shielding films 50, and a liquid crystal layer 60.

The first substrate 10 and the second substrate 20 face each other. The first substrate 10 and the second substrate 20 have a light-transmitting property. The first substrate 10 and the second substrate 20 are, for example, glass substrates, resin substrates, or resin films.

The first electrode sets 30 are arranged in the second direction D2. The first electrode sets 30 each include a first electrode 31 and a second electrode 32, which are disposed on the first substrate 10, and a third electrode 33 and a fourth electrode 34, which are disposed on the second substrate 20.

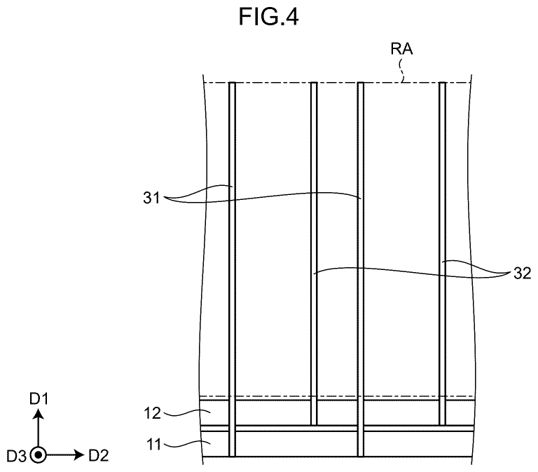

FIG. 4 is a plan view illustrating an arrangement of the first electrodes 31 and the second electrodes 32 illustrated in FIG. 3. The first electrodes 31 and the second electrodes 32 extend in the first direction D1.

As illustrated in FIGS. 3 and 4, in each first electrode set 30, the first electrode 31 and the second electrode 32 face each other in the second direction D2, and the first electrode 31 is positioned on the positive D2 side of the second electrode 32 in the first embodiment. In the second direction D2, the length of each first electrode 31 is equal to the length of each second electrode 32. In the second direction D2, the length of each first electrode 31 may be different from the length of each second electrode 32. In plan view, the first electrodes 31 and the second electrodes 32 overlap a refraction region RA in which the emission light L is refracted.

As illustrated in FIG. 4, the liquid crystal element 1 further includes a first trunk electrode 11 and a second trunk electrode 12 that are disposed on the first substrate 10. The first trunk electrode 11 and the second trunk electrode 12 are disposed apart from each other in plan view. The first trunk electrode 11 and the second trunk electrode 12 are separated from the first electrodes 31 and the second electrodes 32 in the third direction D3.

The first trunk electrode 11 is positioned on the outer side (negative D1 side) of the refraction region RA in plan view and extends in the second direction D2. The first trunk electrode 11 overlaps the first electrodes 31 in plan view and is electrically coupled to the first electrodes 31 through a coupling member. The first trunk electrode 11 is electrically insulated from the second electrodes 32.

The second trunk electrode 12 is positioned on the outer side (negative D1 side) of the refraction region RA in plan view and extends in the second direction D2. The second trunk electrode 12 overlaps the second electrodes 32 in plan view and is electrically coupled to the second electrodes 32 through a coupling member. The second trunk electrode 12 is electrically insulated from the first electrodes 31.

The first and second trunk electrodes 11 and 12 are electrically coupled to a non-illustrated control circuit. The control circuit applies voltage to the first electrodes 31 through the first trunk electrode 11. The control circuit applies voltage to the second electrodes 32 through the second trunk electrode 12.

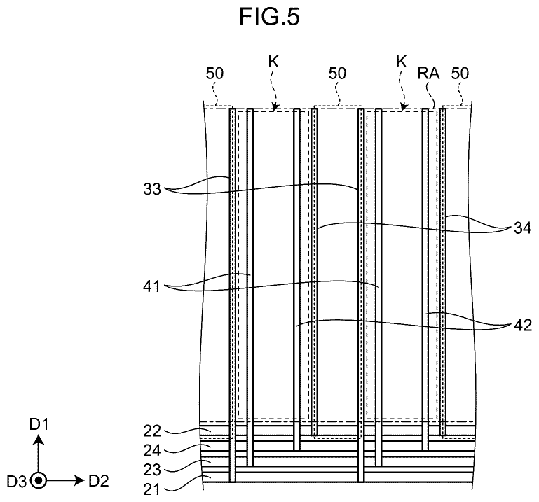

FIG. 5 is a plan view illustrating an arrangement of the third electrodes 33 and the fourth electrodes 34 illustrated in FIG. 3. The third electrodes 33 and the fourth electrodes 34 extend in the first direction D1.

As illustrated in FIGS. 3 and 5, in each first electrode set 30, the third electrode 33 and the fourth electrode 34 face each other in the second direction D2. In the second direction D2, the length of each second electrode 32, the length of each third electrode 33, and the length of each fourth electrode 34 are equal to one another. In the second direction D2, the length of each second electrode 32, the length of each third electrode 33, and the length of each fourth electrode 34 may be different from one another. In plan view, the third electrodes 33 and the fourth electrodes 34 overlap the refraction region RA in which the emission light L is refracted.

As illustrated in FIG. 3, the third electrodes 33 overlap the first electrodes 31 in plan view. The fourth electrodes 34 overlap the second electrodes 32 in plan view.

The first electrode sets 30 and the second electrode sets 40 are alternately arranged in the second direction D2. In other words, each of the second electrode sets 40 is positioned between two adjacent ones of the first electrode sets 30 in the second direction D2. The second electrode sets 40 each include a fifth electrode 41 and a sixth electrode 42, which are disposed on the second substrate 20. As illustrated in FIG. 5, the fifth electrodes 41 and the sixth electrodes 42 extend in the first direction D1.

As illustrated in FIGS. 3 and 5, in each second electrode set 40, the fifth electrode 41 and the sixth electrode 42 face each other in the second direction D2, and the sixth electrode 42 is positioned on the positive D2 side of the fifth electrode 41 in the first embodiment. In the second direction D2, the length of each second electrode 32, the length of each fifth electrode 41, and the length of each sixth electrode 42 are equal to one another. In the second direction D2, the length of each second electrode 32, the length of each fifth electrode 41, and the length of each sixth electrode 42 may be different from one another. In plan view, the fifth electrodes 41 and the sixth electrodes 42 overlap the refraction region RA in which the emission light L is refracted.

As illustrated in FIG. 3, between two adjacent ones of the first electrode sets 30 in the second direction D2, the fifth electrode 41 is positioned closer to one of the two first electrode sets 30 than a bisecting line B that equally divides a space between the two first electrode sets 30 in the second direction D2. In the first embodiment, the fifth electrode 41 is positioned on the negative D2 side of the bisecting line B.

In addition, between two adjacent ones of the first electrode sets 30 in the second direction D2, the sixth electrode 42 is positioned closer to the other of the two first electrode sets 30 than the bisecting line B. In the first embodiment, the sixth electrode 42 is positioned on the positive D2 side of the bisecting line B.

As described above the first electrode sets 30 and the second electrode sets 40 are alternately arranged in the second direction D2. Accordingly, in the first embodiment, the first electrodes 31 and the second electrodes 32 are alternately arranged on the first substrate 10. The third electrodes 33, the fifth electrodes 41, the sixth electrodes 42, and the fourth electrodes 34 are repeatedly arranged in the stated order in the second direction D2 on the second substrate 20. A first length H1 in the second direction D2 between two adjacent ones of the first electrode sets 30 in the second direction D2 is equal to or longer than a second length H2 of each first electrode set 30 in the second direction D2.

As illustrated in FIG. 5, the liquid crystal element 1 further includes a third trunk electrode 21, a fourth trunk electrode 22, a fifth trunk electrode 23, and a sixth trunk electrode 24 disposed on the second substrate 20. The third trunk electrode 21, the fourth trunk electrode 22, the fifth trunk electrode 23, and the sixth trunk electrode 24 are disposed apart from each other in plan view as illustrated in FIG. 4. The third trunk electrode 21, the fourth trunk electrode 22, the fifth trunk electrode 23, and the sixth trunk electrode 24 are separated from the third electrodes 33, the fourth electrodes 34, the fifth electrodes 41, and the sixth electrodes 42 in the third direction D3.

The third trunk electrode 21 is positioned on the outer side (negative D1 side) of the refraction region RA in plan view and extends in the second direction D2. The third trunk electrode 21 overlaps the third electrodes 33 in plan view and is electrically coupled to the third electrodes 33 through a coupling member. The third trunk electrode 21 is electrically insulated from the fourth electrodes 34, the fifth electrodes 41, and the sixth electrodes 42.

The fourth trunk electrode 22 is positioned on the outer side (negative D1 side) of the refraction region RA in plan view and extends in the second direction D2. The fourth trunk electrode 22 overlaps the fourth electrodes 34 in plan view and is electrically coupled to the fourth electrodes 34 through a coupling member. The fourth trunk electrode 22 is electrically insulated from the third electrodes 33, the fifth electrodes 41, and the sixth electrodes 42.

The fifth trunk electrode 23 is positioned on the outer side (negative D1 side) of the refraction region RA in plan view and extends in the second direction D2. The fifth trunk electrode 23 overlaps the fifth electrodes 41 in plan view and is electrically coupled to the fifth electrodes 41 through a coupling member. The fifth trunk electrode 23 is electrically insulated from the third electrodes 33, the fourth electrodes 34, and the sixth electrodes 42.

The sixth trunk electrode 24 is positioned on the outer side (negative D1 side) of the refraction region RA in plan view and extends in the second direction D2. The sixth trunk electrode 24 overlaps the sixth electrodes 42 in plan view and is electrically coupled to the sixth electrodes 42 through a coupling member. The sixth trunk electrode 24 is electrically insulated from the third electrodes 33, the fourth electrodes 34, and the fifth electrodes 41.

The third trunk electrode 21, the fourth trunk electrode 22, the fifth trunk electrode 23, and the sixth trunk electrode 24 are electrically coupled to a non-illustrated control circuit. The control circuit applies voltage to the third electrodes 33 through the third trunk electrode 21. The control circuit applies voltage to the fourth electrodes 34 through the fourth trunk electrode 22. The control circuit applies voltage to the fifth electrodes 41 through the fifth trunk electrode 23. The control circuit applies voltage to the sixth electrodes 42 through the sixth trunk electrode 24.

Hereinafter, the first electrode 31, the second electrode 32, the third electrodes 33, the fourth electrodes 34, the fifth electrodes 41, and the sixth electrodes 42 are simply referred to as “electrodes” when described without distinction. The first trunk electrode 11, the second trunk electrode 12, the third trunk electrode 21, the fourth trunk electrode 22, the fifth trunk electrode 23, and the sixth trunk electrode 24 are simply referred to as “trunk electrodes” when described without distinction.

The material of the electrodes and the trunk electrodes is a conductive material such as molybdenum tungsten alloy (MoW) or TAT (Ti/Al/Ti) in which titanium (Ti) and aluminum (Al) are stacked. In this case, the electrodes and the trunk electrodes have light-shielding properties.

The material of the electrodes and the trunk electrodes may be a translucent conductive material such as indium tin oxide (ITO), indium zinc oxide (IZO), indium gallium oxide (IGO), or indium gallium zinc oxide (IGZO). In this case, the electrodes and the trunk electrodes do not have light-shielding properties (in other words, have light-transmitting properties).

As illustrated in FIG. 3, the liquid crystal element 1 further includes a first insulating layer IL1 and a first alignment film AL1 disposed on the first substrate 10, and a second insulating layer IL2 and a second alignment film AL2 disposed on the second substrate 20.

The first insulating layer IL1 electrically insulates the first trunk electrode 11 and the second trunk electrode 12 from each other. The first insulating layer IL1 also electrically insulates the first electrodes 31 and the second electrodes 32 from each other.

The first alignment film AL1 is disposed on the positive D3 side of the first electrodes 31 and the second electrodes 32. The first alignment film AL1 is disposed in a state of being separated from the first electrodes 31 and the second electrodes 32. The first alignment film AL1 may be in contact with the first electrodes 31 and the second electrodes 32.

The second insulating layer IL2 electrically insulates the third trunk electrode 21, the fourth trunk electrode 22, the fifth trunk electrode 23, and the sixth trunk electrode 24 from one another. The second insulating layer IL2 also electrically insulates the third electrodes 33, the fourth electrodes 34, the fifth electrodes 41, and the sixth electrodes 42 from one another.

The second alignment film AL2 is disposed on the negative D3 side of the third electrodes 33, the fourth electrodes 34, the fifth electrodes 41, and the sixth electrodes 42. The second alignment film AL2 is disposed in a state of being separated from the third electrodes 33, the fourth electrodes 34, the fifth electrodes 41, and the sixth electrodes 42. The second alignment film AL2 may be in contact with the third electrodes 33, the fourth electrodes 34, the fifth electrodes 41, and the sixth electrodes 42.

Light-shielding films 50 illustrated in FIGS. 3 and 5 blocks the transmission of light. The material of the light-shielding film 50 is, for example, molybdenum tungsten alloy (MoW). The light-shielding films 50 are illustrated with dashed lines in FIG. 5. The light-shielding films 50 extend in the first direction D1 and are arranged in the second direction D2. The light-shielding films 50 overlap the refraction region RA in which the emission light L is refracted in plan view. Accordingly, in the refraction region RA, a space between two adjacent ones of the light-shielding films 50 in the second direction D2 corresponds to an opening part K through which light is transmitted.

The light-shielding films 50 each overlaps a gap between the third electrode 33 and the fourth electrode 34 in the corresponding first electrode set 30. In the first embodiment, the light-shielding films 50 each overlap the corresponding first electrode set 30 in plan view, and the length of each light-shielding film 50 in the second direction D2 is equal to the second length H2, which is the length of each first electrode set 30 in the second direction D2. Accordingly, the light-shielding film 50 overlaps the first electrode set 30. Thus, the space between two adjacent ones of the first electrode sets 30 in the second direction D2 corresponds to the opening part K. The length of each opening part K in the second direction D2 corresponds to the first length H1. As described above, the first length H1 is equal to or larger than the second length H2. This allows the opening part K to be larger, thereby improving the efficiency of use of the emission light L.

The liquid crystal layer 60 is positioned between the first substrate 10 and the second substrate 20. The liquid crystal layer 60 is sandwiched between the first alignment film AL1 and the second alignment film AL2. The first alignment film AL1 and the second alignment film AL2 induce a predetermined alignment (initial orientation) of liquid crystal molecules LM contained in the liquid crystal layer 60 when no voltage is applied to the liquid crystal element 1. The initial orientation of the liquid crystal molecules LM is in such a direction (horizontal alignment) that a long axis Ax of each liquid crystal molecule LM is orthogonal to the third direction D3. The alignment direction of the first alignment film AL1 and the alignment direction of the second alignment film AL2 are parallel to each other in plan view.

The liquid crystal element 1 is an electrically controlled birefringence (ECB) liquid crystal element. However, the liquid crystal element 1 is not limited to an ECB liquid crystal element.

The following describes operation when the liquid crystal element 1 refracts the emission light L from the light source S. The liquid crystal element 1 refracts the emission light L when voltage is applied to the electrodes by a control circuit. The emission light L enters the liquid crystal element 1 in the third direction D3 from the back surface of the first substrate 10. A reference sign inside parentheses of the emission light L in the drawings indicates the direction in which the emission light L travels. In FIG. 3, the emission light L from the liquid crystal element 1 is illustrated on the positive D3 side of the liquid crystal element 1.

When no voltage is applied to the electrodes, the alignment states of all liquid crystal molecules LM included in the liquid crystal layer 60 are in initial orientation (horizontal alignment) and all liquid crystal molecules LM have the same tilt degree. Thus, the phase change amount of the emission light L passing through the liquid crystal layer 60 is equal at all portions of the liquid crystal layer 60, and no phase difference occurs to the emission light L. Accordingly, the liquid crystal element 1 emits the emission light L without refraction. Specifically, as illustrated in FIG. 3, the liquid crystal element 1 causes the emission light L incident in the third direction D3 to exit therefrom in the third direction D3 without refraction.

When the liquid crystal element 1 refracts the emission light L from the light source S, voltage is applied to the first electrodes 31, the second electrodes 32, the third electrodes 33, and the fourth electrodes 34 such that the magnitude (ED1) of a first potential difference between the potential (E1) of the first electrodes 31 and the potential (E3) of the third electrodes 33 is different from the magnitude (ED2) of a second potential difference between the potential (E2) of the second electrodes 32 and the potential (E4) of the fourth electrodes 34.

Specifically, when the liquid crystal element 1 refracts the emission light L such that the light travels in a fourth direction D4 tilted to the negative D2 side relative to the third direction D3, voltage is applied to the electrodes such that the magnitude of the second potential difference is larger than the magnitude of the first potential difference (ED1<ED2).

Voltage is applied to the third electrodes 33 and the fourth electrodes 34 such that the potential of the third electrodes 33 is different from the potential of the fourth electrodes 34. A potential between the potential of the third electrodes 33 and the potential of the fourth electrodes 34 is applied to the fifth electrodes 41 and the sixth electrodes 42.

Specifically, voltage is applied to the third electrodes 33, the fourth electrodes 34, the fifth electrodes 41, and the sixth electrodes 42 such that the potential of the fourth electrodes 34 is lower than the potential of the third electrodes 33 and potential decreases in the order of the potential (E3) of the third electrodes 33, the potential (E5) of the fifth electrodes 41, the potential (E6) of the sixth electrodes 42, and the potential (E4) of the fourth electrodes 34 (E3>E5>E6>E4). Voltage may be applied to the third electrodes 33, the fourth electrodes 34, the fifth electrodes 41, and the sixth electrodes 42 such that the potential of the fourth electrodes 34 is higher than the potential of the third electrodes 33 and potential increases in the order of the potential of the third electrodes 33, the potential of the fifth electrodes 41, the potential of the sixth electrodes 42, and the potential of the fourth electrodes 34.

Moreover, the magnitude of the potential difference between the potential of the third electrodes 33 and the potential of the fourth electrodes 34 is larger than the magnitude of the potential difference between the potential of the first electrodes 31 and the potential of the second electrodes 32 (|E3−E4|>|E1−E2|). The magnitude of the potential difference between the potential of the first electrodes 31 and the potential of the second electrodes 32 may be larger than the potential difference between the potential of the third electrodes 33 and the potential of the fourth electrodes 34.

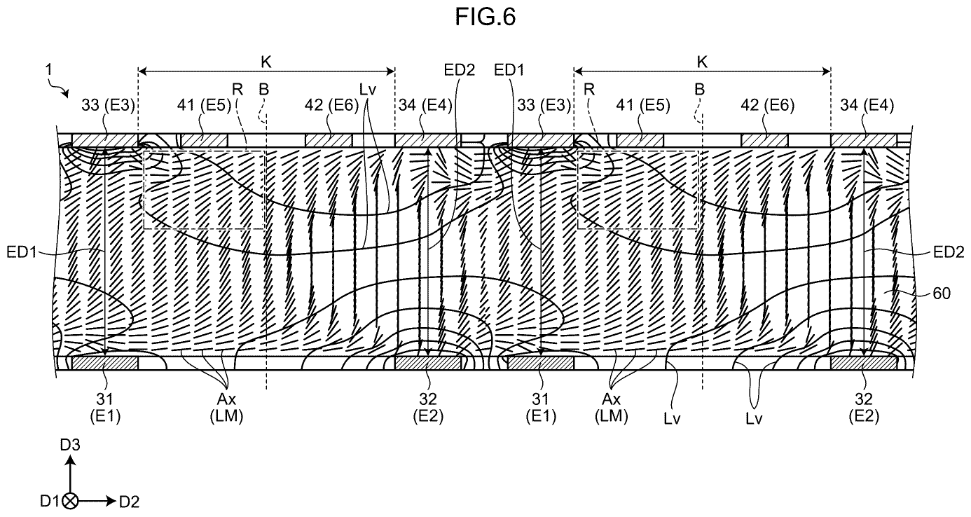

FIG. 6 is a diagram illustrating the tilt degree of the liquid crystal molecules LM when the liquid crystal element 1 illustrated in FIG. 3 refracts the emission light L in the fourth direction D4. In FIG. 6, the liquid crystal molecules LM are represented only by the long axes Ax of the liquid crystal molecules LM. Potential lines Lv of an electric field generated in the liquid crystal layer 60 are illustrated in FIG. 6. The initial orientation of the liquid crystal molecules LM is horizontal alignment as described above. Accordingly, when no voltage is applied to the electrodes, the long axes Ax of the liquid crystal molecules LM align with the second direction D2.

When voltage is applied to the electrodes, an electric field acts on the liquid crystal layer 60, causing the liquid crystal molecules LM to tilt. As the magnitude of the potential difference in the third direction D3 increases in the liquid crystal layer 60, the tilt degree of the liquid crystal molecules LM increases (the angles of the long axes Ax of the liquid crystal molecules LM relative to the second direction D2 increase).

As the tilt degree of the liquid crystal molecules LM increases, the phase of the emission light L passing through the liquid crystal layer 60 advances. In other words, as the magnitude of the potential difference in the third direction D3 in the liquid crystal layer 60 increases, the phase of the emission light L advances.

When the liquid crystal element 1 refracts the emission light L such that the light travels in the fourth direction D4, the magnitude (ED2) of the second potential difference is larger than the magnitude (ED1) of the first potential difference as described above (ED1<ED2). Accordingly, the tilt degree of the liquid crystal molecules LM between the second and fourth electrodes 32 and 34 is larger than the tilt degree of the liquid crystal molecules LM between the first and third electrodes 31 and 33.

In the state illustrated in FIG. 6, voltage is applied to the electrodes such that the potential (E2) of the second electrodes 32 is larger than the potential (E1) of the first electrodes 31 (E1<E2) and the potential (E3) of the third electrodes 33 is larger than the potential (E4) of the fourth electrodes 34 (E4<E3).

In FIG. 6, the potential (E3) of the third electrodes 33 is larger than the potential (E1) of the first electrodes 31 (E1<E3), the potential (E1) of the first electrodes 31 is larger than the potential (E4) of the fourth electrodes 34 (E4<E1), and the potential (E2) of the second electrodes 32 is equal to the potential (E3) of the third electrodes 33 (E2=E3). Thus, the electrode potential relation in FIG. 6 is expressed by Expression (1) below.

$$E 4 < E 1 < E 2 = E 3 \qquad ( 1 )$$

Moreover, in FIG. 6, the potential (E2) of the second electrodes 32 and the potential (E4) of the fourth electrodes 34 have the same magnitude but opposite polarities as expressed by Expression (2).

$$E 2 = ( - 1 ) \times E 4 \qquad ( 2 )$$

When the electrode potential relation satisfies the relation of Expressions (1) and (2), the electrode potential can be controlled by a column inversion driving method in which the polarity of the electrode potential is periodically inverted. The electrode potential relation is not limited to the relation of Expressions (1) and (2).

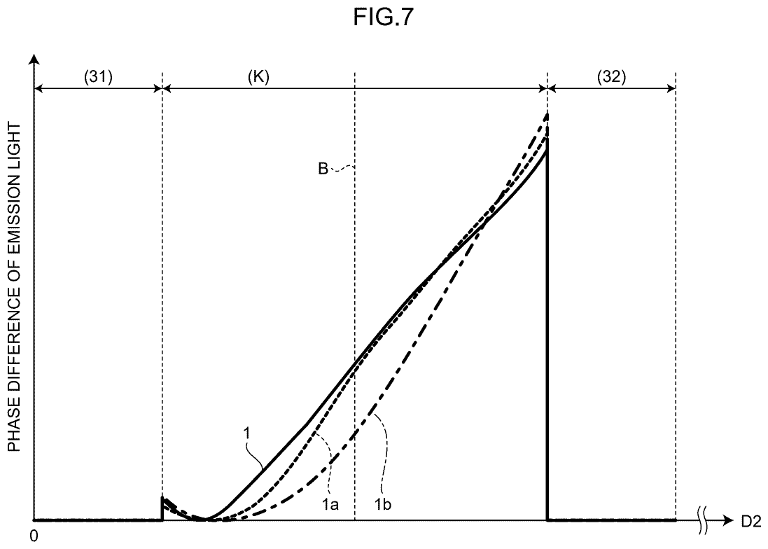

FIG. 7 is a diagram illustrating the phase difference of the emission light L passing through the liquid crystal layer 60 of the liquid crystal element 1 illustrated in FIG. 6. FIG. 7 illustrates a case where the electrode potential relation is the relation represented by Expressions (1) and (2) and voltage is applied to the electrodes such that the magnitude (ED2) of the second potential difference is twice the magnitude (ED1) of the first potential difference. In FIG. 7, the potential of the fifth electrodes 41 and the potential of the sixth electrodes 42 are closer to the potential of the fourth electrodes 34 than to the midpoint potential between the potential of the third electrodes 33 and the potential of the fourth electrodes 34.

The vertical axis in FIG. 7 represents the phase difference of the emission light L. The horizontal axis in FIG. 7 represents the position in the second direction D2 in the liquid crystal layer 60. In FIG. 7, the region of “(31)” represents the region of a first electrode 31 in the second direction D2, and the region of “(32)” represents the region of a second electrode 32 in the second direction D2. FIG. 7 illustrates, with a solid line, the phase difference of the emission light L passing through the liquid crystal layer 60 in the liquid crystal element 1 of the first embodiment when the phase of the emission light L passing between the first electrode 31 and the corresponding third electrode 33 is a reference (zero).

Since the magnitude of the second potential difference is larger than the magnitude of the first potential difference (ED1<ED2), the phase difference increases from the negative D2 side toward the positive D2 side in the second direction D2 at the opening part K. In other words, the phase of the emission light L passing through the liquid crystal layer 60 advances from the negative D2 side toward the positive D2 side in the second direction D2 at the opening part K. Accordingly, the emission light L is refracted to be emitted in the fourth direction D4.

In a case where the liquid crystal element 1 refracts the emission light L such that the light travels in a fifth direction D5 tilted to the positive D2 side relative to the third direction D3, voltage is applied to the electrodes such that the magnitude (ED1) of the first potential difference is larger than the magnitude (ED2) of the second potential difference (ED2<ED1).

Voltage is applied to the third electrodes 33, the fourth electrodes 34, the fifth electrodes 41, and the sixth electrodes 42 such that the potential of the fourth electrodes 34 is higher than the potential of the third electrodes 33 and potential increases in the order of the potential of the third electrodes 33, the potential of the fifth electrodes 41, the potential of the sixth electrodes 42, and the potential of the fourth electrodes 34 (E3<E5<E6<E4). Voltage may be applied to the third electrodes 33, the fourth electrodes 34, the fifth electrodes 41, and the sixth electrodes 42 such that the potential of the fourth electrodes 34 is lower than the potential of the third electrodes 33 and potential decreases in the order of the potential of the third electrodes 33, the potential of the fifth electrodes 41, the potential of the sixth electrodes 42, and the potential of the fourth electrodes 34.

Moreover, the potential difference between the potential of the third electrodes 33 and the potential of the fourth electrodes 34 is larger than the potential difference between the potential of the first electrodes 31 and the potential of the second electrodes 32.

In this case, the electrode potential relation may be the relation represented by Expressions (3) and (4) below.

$$E 3 < E 2 < E 1 = E 4 \qquad ( 3 )$$

$$E 1 = ( - 1 ) \times E 3 \qquad ( 4 )$$

When the electrode potential relation satisfies the relation of Expressions (3) and (4), the electrode potential can be controlled by the column inversion driving method in which the polarity of the electrode potential is periodically inverted. The electrode potential relation is not limited to the relation of Expressions (3) and (4).

Since the magnitude of the first potential difference is larger than the magnitude of the second potential difference (ED2<ED1), the phase difference in the third direction D3 increases from the positive D2 side toward the negative D2 side in the second direction D2 at the opening part K. In other words, the phase of the emission light L passing through the liquid crystal layer 60 advances from the positive D2 side toward the negative D2 side in the second direction D2 at the opening part K. Accordingly, the emission light L is refracted to be emitted in the fifth direction D5.

In this manner, the liquid crystal element 1 can easily control the emission direction of the emission light L by controlling voltage applied to the electrodes.

The following describes a liquid crystal element 1a of a first comparative example and a liquid crystal element 1b of a second comparative example with a focus on difference from the liquid crystal element 1 of the above-described first embodiment.

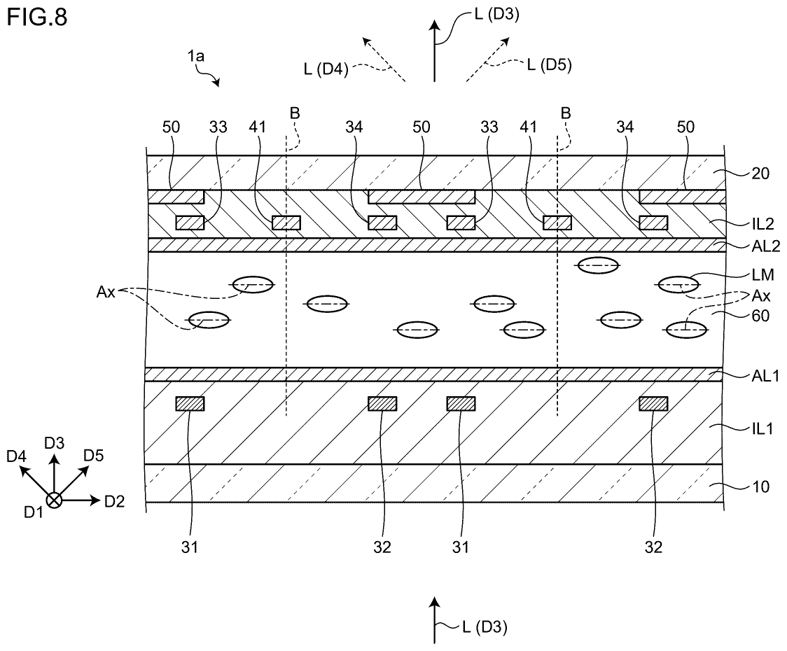

FIG. 8 is a sectional view of the liquid crystal element 1a of the first comparative example. Unlike the above-described liquid crystal element 1, the liquid crystal element 1a of the first comparative example does not include the sixth electrodes 42. The fifth electrode 41 overlaps the bisecting line B.

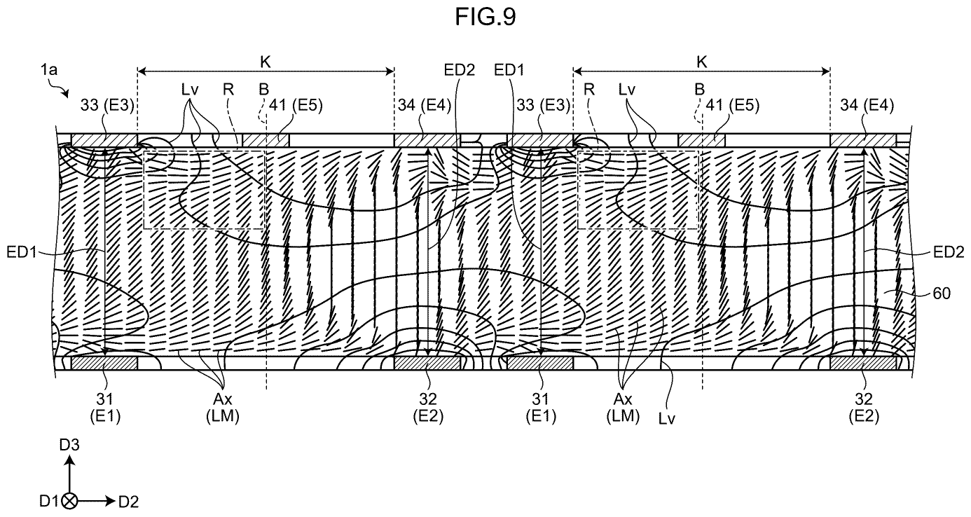

FIG. 9 is a diagram illustrating the tilt degree of the liquid crystal molecules LM when the liquid crystal element 1a of the first comparative example illustrated in FIG. 8 refracts the emission light L in the fourth direction D4. In the liquid crystal element 1a of the first comparative example, the potentials of the first electrodes 31, the second electrodes 32, the third electrodes 33, and the fourth electrodes 34 are equal to the potentials of the electrodes of the liquid crystal element 1 illustrated in FIG. 6. The potential of the fifth electrodes 41 is the midpoint potential between the potential of the fifth electrodes 41 and the potential of the sixth electrodes 42 in FIG. 6.

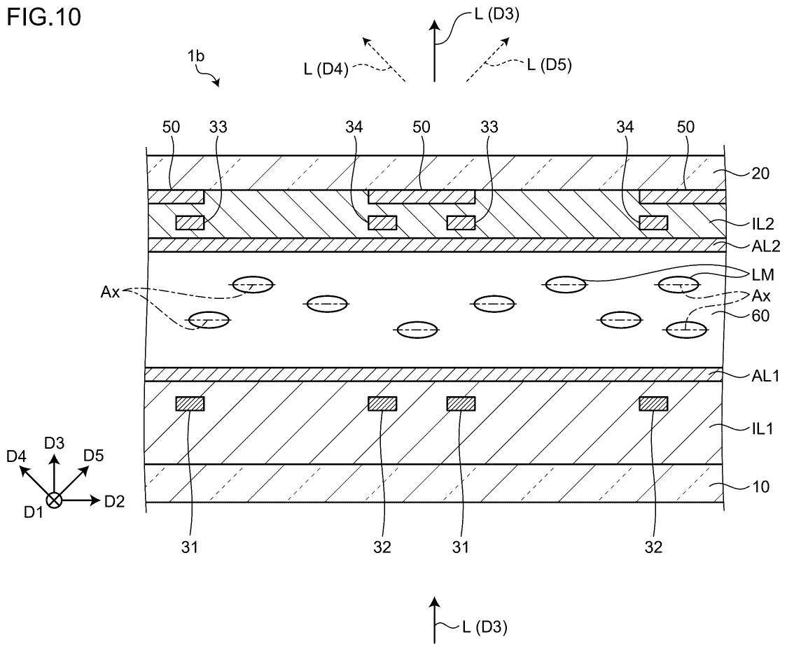

FIG. 10 is a sectional view of the liquid crystal element 1b of the second comparative example. Unlike the above-described liquid crystal element 1, the liquid crystal element 1b of the second comparative example does not include the second electrode sets 40.

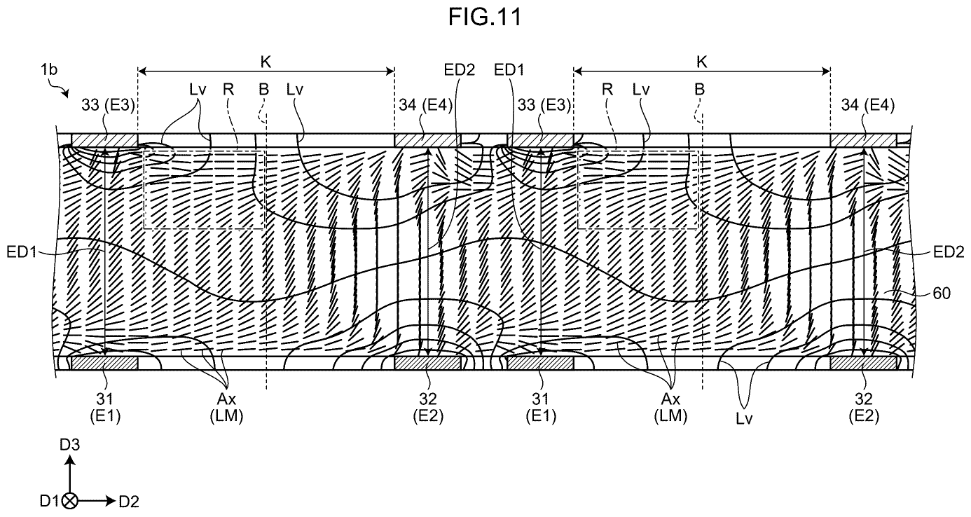

FIG. 11 is a diagram illustrating the tilt degree of the liquid crystal molecules LM when the liquid crystal element 1b of the second comparative example illustrated in FIG. 10 refracts the emission light L in the fourth direction D4. In the liquid crystal element 1b of the second comparative example, the potentials of the first electrodes 31, the second electrodes 32, the third electrodes 33, and the fourth electrodes 34 are equal to the potentials of the electrodes of the liquid crystal element 1 illustrated in FIG. 6.

In a region R of the liquid crystal layer 60 near the second substrate 20 and on the negative D2 side of the bisecting line B in each opening part K illustrated in FIGS. 6, 9, and 11, the tilt degree of the liquid crystal molecules LM decreases in the order of the above-described liquid crystal element 1 (FIG. 6), the liquid crystal element 1a of the first comparative example (FIG. 9), and the liquid crystal element 1b of the second comparative example (FIG. 11). Such decrease in the tilt degree of the liquid crystal molecules LM indicates that the phase difference of the emission light L is unlikely to occur and the emission light L is unlikely to be refracted.

Accordingly, between the first electrode 31 and the bisecting line B as illustrated in FIG. 7, the phase difference of the emission light L decreases in the order of the above-described liquid crystal element 1 (FIG. 6), the liquid crystal element 1a of the first comparative example (FIG. 9), and the liquid crystal element 1b of the second comparative example (FIG. 11), and the phase difference approaches zero. In other words, between the first electrode 31 and the bisecting line B, the refraction angle of the emission light L is smaller in the liquid crystal element 1a of the first comparative example and the liquid crystal element 1b of the second comparative example than in the above-described liquid crystal element 1. Between the bisecting line B and the second electrode 32, the phase difference is smaller in the liquid crystal element 1b of the second comparative example than in the above-described liquid crystal element 1 and the liquid crystal element 1a of the first comparative example.

Thus, the tilt degree of the liquid crystal molecules LM can be increased by disposing electrodes between the third electrode 33 and the fourth electrode 34 in the second direction D2 as in the above-described liquid crystal element 1 (refer to FIGS. 6, 9, and 11). When the emission light L is refracted in the fourth direction D4, the tilt degree of the liquid crystal molecules LM can be further increased by disposing an electrode (fifth electrode 41) on the third electrode 33 side of a midpoint P as in the above-described liquid crystal element 1 (refer to FIGS. 6 and 9).

Accordingly, in the above-described liquid crystal element 1, as compared to the liquid crystal element 1a of the first comparative example and the liquid crystal element 1b of the second comparative example, the phase difference of the emission light L is large between the first electrode 31 and the bisecting line B as illustrated in FIG. 7, and hence the refraction angle of the emission light L is large. Thus, the above-described liquid crystal element 1 can refract the emission light L in a desired direction as compared to the liquid crystal element 1a of the first comparative example and the liquid crystal element 1b of the second comparative example.

Moreover, the magnitude of the potential difference between the potential of the third electrodes 33 and the potential of the fourth electrodes 34 is larger than the magnitude of the potential difference between the potential of the first electrodes 31 and the potential of the second electrodes 32 as described above. Thus, in a case where the fifth electrodes 41 and the sixth electrodes 42 are disposed between the third electrodes 33 and the fourth electrodes 34 on the second substrate 20, the tilt degree of the liquid crystal molecules LM can be increased in the second direction D2 as compared to a case where they are disposed between the first electrodes 31 and the second electrodes 32 on the first substrate 10.

### Second Embodiment

The following describes the liquid crystal element 1 according to a second embodiment of the present disclosure with a focus on difference from the liquid crystal element 1 of the above-described first embodiment.

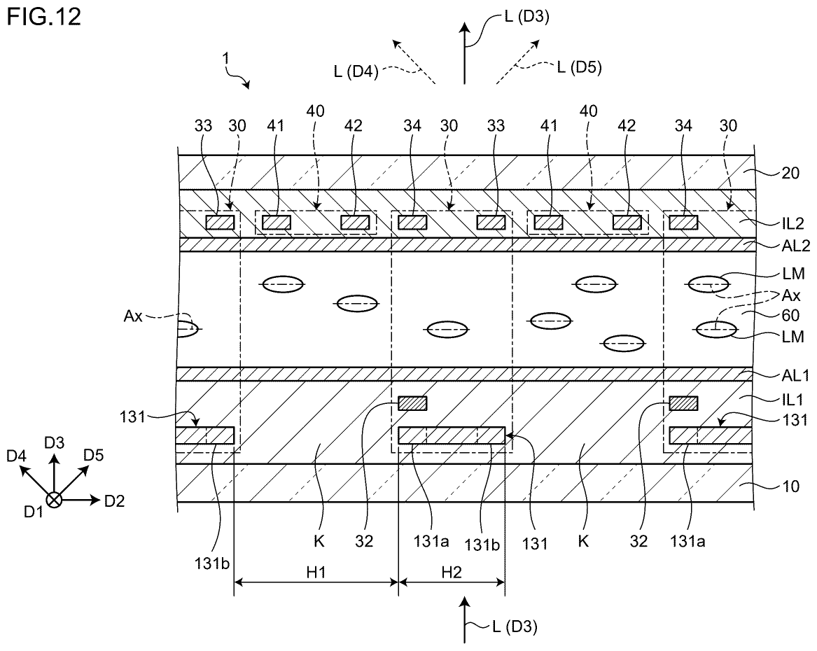

FIG. 12 is a sectional view of the liquid crystal element 1 according to the second embodiment of the present disclosure. Unlike the liquid crystal element 1 of the above-described first embodiment, the liquid crystal element 1 of the second embodiment does not include the light-shielding films 50. Moreover, the shapes and positions of first electrodes 131 in the liquid crystal element 1 of the second embodiment are different from those of the first electrodes 31 in the liquid crystal element 1 of the above-described first embodiment.

In the second direction D2, the length of each first electrode 131 is longer than the length of each second electrode 32, the length of each third electrode 33, and the length of each fourth electrode 34. The length of each first electrode 131 corresponds to the second length H2. The first electrodes 131 are disposed closer to the first substrate 10 than the second electrodes 32 are. In plan view, the second electrode 32 and the fourth electrode 34 overlap a first end portion 131a of the corresponding first electrode 131 on a first end side (negative D2 side) in the second direction D2. In plan view, the third electrode 33 overlaps a second end portion 131b of the corresponding first electrode 131 on a second end side (positive D2 side) in the second direction D2.

The first electrodes 131 have light-shielding properties. Accordingly, the first electrodes 131 function as light-shielding films. The material of the first electrodes 131 is a conductive material such as molybdenum tungsten alloy (MoW) or TAT (Ti/Al/Ti) in which titanium (Ti) and aluminum (Al) are stacked. In the refraction region RA, each opening part K in the second embodiment corresponds to a region between two adjacent ones of the first electrodes 131 in the second direction D2.

Similarly to the liquid crystal element 1 of the above-described first embodiment, the liquid crystal element 1 of the second embodiment refracts the emission light L when voltage is applied to the electrodes.

### Third Embodiment

The following describes the liquid crystal element 1 according to a third embodiment of the present disclosure with a focus on difference from the liquid crystal element 1 of the above-described second embodiment.

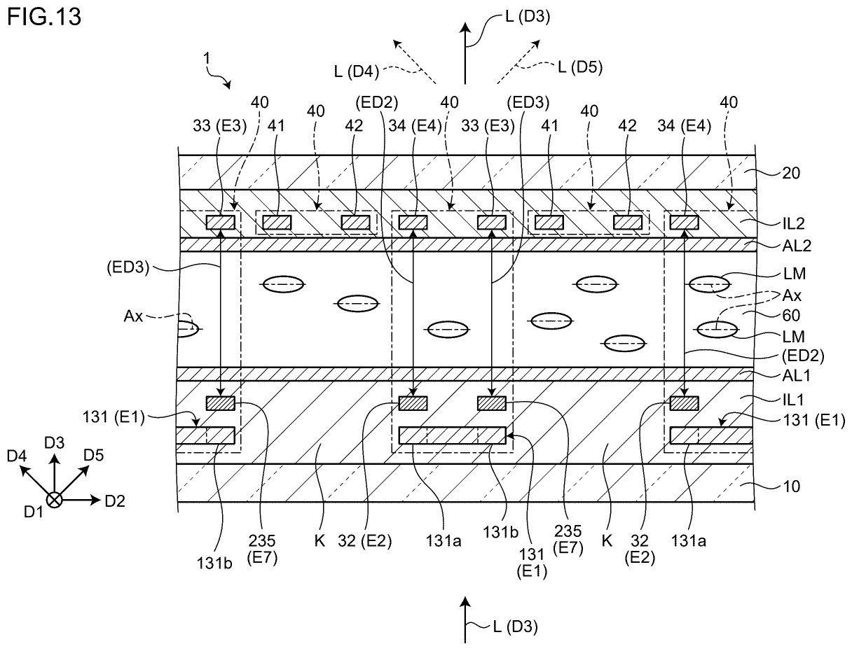

FIG. 13 is a sectional view of the liquid crystal element 1 according to the third embodiment of the present disclosure. Unlike the liquid crystal element 1 of the above-described second embodiment, the liquid crystal element 1 of the third embodiment further includes seventh electrodes 235 included in the first electrode sets 30. The seventh electrodes 235 are disposed closer to the second substrate 20 side than the first electrodes 131 are.

The seventh electrodes 235 extend in the first direction D1. In the second direction D2, the length of each seventh electrode 235 is equal to the length of each third electrode 33. The seventh electrode 235 overlaps the second end portion 131b of the first electrode 131 and the third electrode 33 in plan view.

When the liquid crystal element 1 of the third embodiment refracts the emission light L from the light source S, voltage is applied to the second electrodes 32, the third electrodes 33, the fourth electrodes 34, and the seventh electrodes 235 such that the magnitude (ED2) of the second potential difference between the potential (E2) of the second electrodes 32 and the potential (E4) of the fourth electrodes 34 is different from the magnitude (ED3) of a third potential difference between the potential (E3) of the third electrodes 33 and the potential (E7) of the seventh electrodes 235.

Specifically, when the liquid crystal element 1 refracts the emission light L such that the emission light L travels in the fourth direction D4, voltage is applied to the electrodes such that the magnitude of the second potential difference is larger than the magnitude of the third potential difference (ED3<ED2).

On the other hand, when the liquid crystal element 1 refracts the emission light L such that the emission light L travels in the fifth direction D5, voltage is applied to the electrodes such that the magnitude of the third potential difference is larger than the magnitude of the second potential difference (ED2<ED3).

A potential between the potential of the second electrodes 32 and the potential of the third electrodes 33 is applied to the first electrodes 131. The magnitude of the potential difference between the potential of the third electrodes 33 and the potential of the fourth electrodes 34 is larger than the magnitude of the potential difference between the potential of the seventh electrodes 235 and the potential of the second electrodes 32 (|E3−E4|>|E7−E2|). The magnitude of the potential difference between the potential of the seventh electrodes 235 and the potential of the second electrodes 32 may be larger than the potential difference between the potential of the third electrodes 33 and the potential of the fourth electrodes 34.

When voltage is applied in this manner, the liquid crystal element 1 refracts the emission light L in the same manner as the liquid crystal element 1 of the above-described first embodiment.

### Modifications

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, in the first embodiment, the light-shielding films 50 may be disposed on the first substrate 10. In this case, each light-shielding film 50 overlaps the gap between the first electrode 31 and the second electrode 32 in the corresponding first electrode set 30.

In the above-described embodiments, the fifth electrodes 41 and the sixth electrodes 42 may be disposed on the first substrate 10. In this case as well, the first electrode sets 30 and the second electrode sets 40 are alternately arranged in the second direction D2. In this case, in the liquid crystal element 1 of the first embodiment and the liquid crystal element 1 of the second embodiment, the magnitude of the potential difference between the potential of the first electrodes 31 and 131 and the potential of the second electrodes 32 may be larger than the potential difference between the potential of the third electrodes 33 and the potential of the fourth electrodes 34 (|E1−E2|>|E3−E4|). Moreover, in this case, in the liquid crystal element 1 of the third embodiment, the magnitude of the potential difference between the potential of the seventh electrodes 235 and the potential of the second electrodes 32 may be larger than the potential difference between the potential of the third electrodes 33 and the potential of the fourth electrodes 34 (|E7−E2|>|E3−E4|).

In the above-described embodiments, the second electrode sets 40 may further include eighth electrodes and ninth electrodes disposed on the first substrate 10. The eighth electrodes and the ninth electrodes extend in the first direction D1 and are disposed between the first electrodes 131 and the second electrodes 32 (in the third embodiment, between the seventh electrodes 235 and the second electrodes 32). In the second direction D2, the length of each eighth electrode and the length of each ninth electrode are equal to the length of each second electrode 32. The length of each eighth electrode and the length of each ninth electrode may be different from the length of each second electrode 32. Moreover, the eighth electrodes may overlap the fifth electrodes 41 in plan view. The ninth electrodes may overlap the sixth electrodes 42 in plan view. In the liquid crystal element 1 of the first embodiment and the liquid crystal element 1 of the second embodiment, potentials between the potential of the first electrodes 31 and 131 and the potential of the second electrodes 32 are applied to the eighth electrodes and the ninth electrodes. In the liquid crystal element 1 of the third embodiment, potentials between the potential of the seventh electrodes 235 and the potential of the second electrodes 32 are applied to the eighth electrodes and the ninth electrodes.

It should be understood that the present disclosure provides any other effects achieved by aspects described above in the above-described embodiments, such as effects that are clear from the description of the present specification or effects that could be thought of by the skilled person in the art as appropriate.

What is claimed is:

1. A liquid crystal element comprising:
a first substrate and a second substrate facing each other;
a plurality of first electrode sets each including a first electrode, a second electrode, a third electrode, and a fourth electrode, the first and second electrodes being disposed on the first substrate, the third and fourth electrodes being disposed on the second substrate;
a plurality of second electrode sets each including a fifth electrode and a sixth electrode, the fifth and sixth electrodes being disposed on the second substrate;
a liquid crystal layer positioned between the first and second substrates; and
a plurality of light-shielding films, wherein
in each of the first electrode sets,
the first and second electrodes extend in a first direction and face each other in a second direction orthogonal to the first direction,
the third electrode extends in the first direction and overlaps the first electrode in plan view, and
the fourth electrode extends in the first direction and overlaps the second electrode in plan view,
the fifth and sixth electrodes in each of the second electrode sets extend in the first direction and face each other in the second direction,
the first and second electrode sets are alternately arranged in the second direction, and
the light-shielding films each overlap a gap between the third and fourth electrodes in a corresponding one of the first electrode sets in plan view.

2. The liquid crystal element according to claim 1, wherein between two adjacent ones of the first electrode sets in the second direction in a sectional shape when cut along a plane orthogonal to the first direction,
the fifth electrode is positioned closer to one of the two first electrode sets than a bisecting line that equally divides a space between the two first electrode sets in the second direction, and
the sixth electrode is positioned closer to the other of the two first electrode sets than the bisecting line.

3. The liquid crystal element according to claim 1, wherein a first length in the second direction between two adjacent ones of the first electrode sets in the second direction is equal to or longer than a second length of each of the first electrode sets in the second direction.

4. The liquid crystal element according to claim 1, wherein voltage is applied to the first electrodes, the second electrodes, the third electrodes, and the fourth electrodes such that magnitude of a first potential difference between a potential of the first electrodes and a potential of the third electrodes is different from magnitude of a second potential difference between a potential of the second electrodes and a potential of the fourth electrodes.

5. The liquid crystal element according to claim 1, wherein
voltage is applied to the third and fourth electrodes such that a potential of the third electrodes is different from a potential of the fourth electrodes, and
a potential between the potential of the third electrodes and the potential of the fourth electrodes is applied to the fifth and sixth electrodes.

6. The liquid crystal element according to claim 5, wherein magnitude of a potential difference between the potential of the third electrodes and the potential of the fourth electrodes is larger than magnitude of a potential difference between a potential of the first electrodes and a potential of the second electrodes.

7. A liquid crystal element comprising:
a first substrate and a second substrate facing each other;
a plurality of first electrode sets each including a first electrode, a second electrode, a third electrode, and a fourth electrode, the first and second electrodes being disposed on the first substrate, the third and fourth electrodes being disposed on the second substrate;
a plurality of second electrode sets disposed on the second substrate and each including a fifth electrode and a sixth electrode; and
a liquid crystal layer positioned between the first and second substrates, wherein
the first, second, third, and fourth electrodes extend in a first direction,
a length of each of the first electrodes is longer than a length of each of the second electrodes, a length of each of the third electrodes, and a length of each of the fourth electrodes in a second direction orthogonal to the first direction,
in one of the first electrode sets,
the second electrode is disposed closer to the second substrate than the first electrode and overlaps, in plan view, a first end portion of the first electrode on a first end side in the second direction,
the third electrode overlaps, in plan view, a second end portion of the first electrode on a second end side in the second direction, and
the fourth electrode overlaps the second electrode in plan view,
the fifth and sixth electrodes in each of the second electrode sets extend in the first direction and face each other in the second direction,
the first and second electrode sets are alternately arranged in the second direction, and
the first electrodes have light-shielding properties.

8. The liquid crystal element according to claim 7, wherein
the first electrode sets each further include a seventh electrode disposed on the first substrate and extending in the first direction, and
in each of the first electrode sets, the seventh electrode is disposed closer to the second substrate than the first electrode and overlaps the third electrode in plan view.

9. The liquid crystal element according to claim 8, wherein voltage is applied to the second, third, and fourth, and seventh electrodes such that magnitude of a second potential difference between a potential of the second electrodes and a potential of the fourth electrodes is different from magnitude of a third potential difference between a potential of the third electrodes and a potential of the seventh electrodes.
